(19) United States
(12) Patent Application Publication
(10) Pub. No.: US 2008/0140691 A1
(43) Pub. Date: Jun. 12, 2008

(54) Method, Device and Computer Program Product for Optimizing File Placement in a Storage System

(76) Inventors: Chuang Li, Beijing (CN); Min Qu, Beijing (CN); Qing Bo Wang, Beijing (CN); Zhe Xiang, Beijing (CN)

Correspondence Address: IBM CORPORATION;INTELLECTUAL PROPERTY LAW, 11400 BURNET ROAD, AUSTIN, TX, 78758, US

(21) Appl. No.: 11/860,572

(22) Filed: Sep. 25, 2007

(30) Foreign Application Priority Data
Dec. 8, 2006 (CN) 200610164588.X

(51) Int. Cl. G06F 17/30

(52) U.S. Cl. 707/101; 707/E17.005

(57) ABSTRACT

A method, device and computer program product for optimizing file placement in a storage system, grouping multiple files into at least one set according to access correlation between the multiple files in the storage system; and placing each of the at least one set of files collectively in one storage region of the storage system. By using the method of the present invention, an application can access the associated files efficiently by obtaining the access correlation between the files and placing the files which have the access correlation with each other collectively in one storage region, thereby improving file access performance of the application and reducing resources such as CPU, memory and I/O interface.

### TECHNICAL FIELD OF THE INVENTION

The present invention relates to a technique of file placement in a storage system, specifically to a method and device for optimizing file placement in a storage system.

### BACKGROUND

A file storage system plays an important role for applications to conduct complex data processing tasks. Nowadays, applications become more and more sophisticated, and accordingly more and more files are required. For example, a web page of an online shop or an online map usually contains tens of page elements and each web page is constituted by multiple files. A newly developed electronic office document also needs to refer to more than tens of related file resources for rendering. Therefore, the manner of file placement in the storage system such as hard disk would have great effect on file access performance of the applications. For example, if the files are placed too separately, when the application is executed, the cost of accessing files through I/O interface would be increased.

For the applications of the above online shop or online map, a set of files including multiple files of one web page are accessed simultaneously with high possibility. The file access request of these applications always follows a fixed manner, and a certain set of files are always accessed simultaneously. Generally, each file of the set is separately placed in multiple discontinuous blocks of the hard disk, thus the I/O costs are increased and the response speed is reduced while reading or writing these files.

A disk de-fragment tool in the prior art is provided to place a plurality of pieces of a file in a continuous storage space. When a file is read, it is high probability that the respective pieces of the file are read in sequence. In this way, the disk de-fragment tool would improve the efficiency of reading the file. However, the disk de-fragment tool treats all files equally and does not consider correlation between the files. So the disk de-fragment tool still places files of the file set randomly in the storage space, which may cause a high latency of hard disk, for example, when a web page is accessed.

### SUMMARY

The present invention is directed to the above technical problem and its objective is to provide a method and device for optimizing file placement in a storage system which can adjust the placement of the files in the storage system according to an application, so as to improve file access performance of the application, and to reduce consumption of the resources such as CPU, memory, I/O interface and bus, etc.

According to one aspect of the present invention, it is provided that a method for optimizing file placement in a storage system, comprising: grouping multiple files in the storage system into at least one set according to access correlation between the multiple files; and placing each of the at least one set of files collectively in one storage region of the storage system.

According to another aspect of the present invention, it is provided that a device for optimizing file placement in a storage system, comprising: a grouping unit for grouping multiple files in the storage system into at least one set according to access correlation between the multiple files; and a file placement unit for placing each of the at least one set of files collectively in one storage region of the storage system.

### BRIEF DESCRIPTION OF THE DRAWINGS

FIG. 1 is a flowchart of a method for optimizing file placement in a storage system according to one embodiment of the present invention;

FIG. 2 is a flowchart of a method for optimizing file placement in a storage system according to another embodiment of the present invention;

FIG. 3 is a flowchart of a method for optimizing file placement in a storage system according to another embodiment of the present invention;

FIG. 4 is a flowchart of a method for optimizing file placement in a storage system according to another embodiment of the present invention;

FIG. 5 is a flowchart of a method for optimizing file placement in a storage system according to another embodiment of the present invention;

FIG. 6 is a flowchart of a method for optimizing file placement in a storage system according to another embodiment of the present invention;

FIG. 7 is a schematic block diagram of a device for optimizing file placement in a storage system according to one embodiment of the present invention;

FIG. 8 is a schematic block diagram of a device for optimizing file placement in a storage system according to another embodiment of the present invention;

FIG. 9 is a schematic block diagram of a device for optimizing file placement in a storage system according to another embodiment of the present invention;

FIG. 10 is a schematic block diagram of a device for optimizing file placement in a storage system according to another embodiment of the present invention;

FIG. 11 is a schematic block diagram of a device for optimizing file placement in a storage system according to another embodiment of the present invention;

FIG. 12 is a schematic block diagram of a device for optimizing file placement in a storage system according to another embodiment of the present invention.

### DETAILED DESCRIPTION

It is believed that the above and other objectives, features and advantages of the present invention will become apparent with reference to the following detailed description of the embodiments of the present invention in conjunction with the drawings.

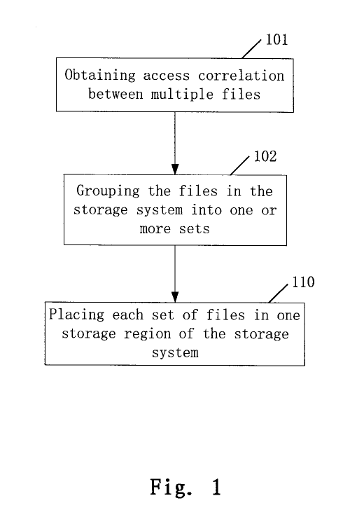

FIG. 1 is a flowchart of a method for optimizing file placement in a storage system according to one embodiment of the present invention;

As shown in FIG. 1, first at Step 101, access correlation between multiple files in a storage system is obtained. Here, the access correlation means factors which affect speed of accessing the multiple files by the storage system. Specifically, the access correlation between the files can be obtained from the contents of the files in the storage system. For example, one word file includes several picture resource files. The several picture resources are required to be accessed while accessing the word file. Hence, there is the access correlation between the resources.

In addition, if a file is of a markup language format, the access correlation between the files can be obtained by analyzing reference relationship between a file and other one or more files. For example, assuming that a web page of a certain online shop contains 5 web page resources, each of which generally corresponds to a web file and multiple picture resources, when the web page of the online shop is requested to be presented, each of the web page resources will be accessed simultaneously. So there is the access correlation between the web resources, but the access correlation between different web pages is weak.

In other embodiment, the access correlation between multiple files can be obtained by analyzing a database. The logical relations between the files are implied in the structures of the database, thus, the access correlation between the files can be obtained by using expert tools for analyzing the structure of the database.

In other embodiment, the access correlation between multiple files can be obtained by analyzing behaviors of an application. The application behaviors, such as accessing or invoking the file, can reflect the access correlation between the files to some degrees. In this case, an expert tool for monitoring/analyzing the behaviors of an application is required by an operating system.

In other embodiment, the access correlation between the files can also be marked directly by the user.

Several implementations of obtaining the access correlation between multiple files are illustrated. However, other implementations known by persons skilled in the art can also be used.

Then, at Step 102, the files in the storage system are grouped into one or more sets based on the obtained access correlation between the files. The file grouping is to group the files which have the access correlation with each other into one set. If there is one access correlation between all files in the storage system, all files are grouped into one set. If there are more than one access correlations, all files are grouped into a plurality of sets. The files within each set have the access correlation with each other.

Then, at Step 110, each of the one or more sets of files is placed collectively in one storage region of the storage system. In the prior art, the files are usually placed randomly. As a result, multiple files required by the same application may be placed very separately, which leads to high file access operation latency. In order to solve such a problem, in this embodiment, one set of files which have access correlation with each other, i.e. the files associated with the same application, is placed collectively in one storage region of the storage system, for example, a sector or several continuous sectors of hard disk.

Although the embodiment of optimizing the placement of one set of files which have the access correlation with each other has been described as above, it would be easy for persons skilled in the art to know that this embodiment can also be applied to optimize the placement of a plurality of sets of files which have the access correlation with each other.

It can be seen from above description that the method for optimizing file placement in a storage system of the embodiment can facilitate applications to access the associated files by obtaining the access correlation between the files and placing the files which have the access correlation with each other collectively in one storage region, so that the file access performance of the application is improved and the consumption of the resources such as CPU, memory, and I/O interface is reduced.

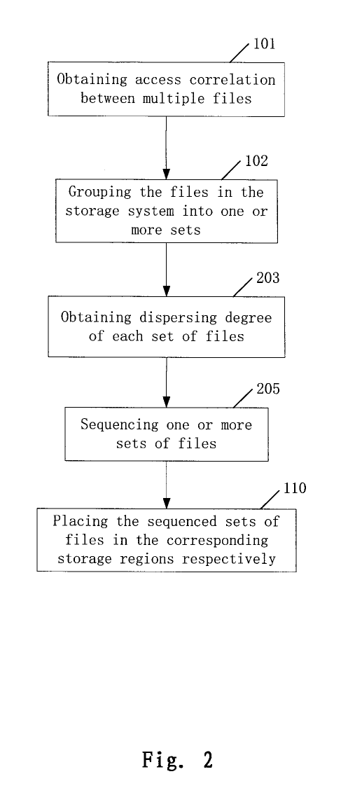

FIG. 2 is a flowchart of a method for optimizing file placement in a storage system according to another embodiment of the present invention, wherein the same parts as those of the previous embodiment use the same reference numbers and their description are omitted properly. This embodiment will be described in details as below in conjunction with the drawing.

As shown in FIG. 2, after Step 102 of FIG. 1 is performed, at Step 203, dispersing degree of each set of files in the storage system can be obtained. In this embodiment, the dispersing degree can be measured based on location where each file in the set of files is placed in the storage system. For example, if the storage system is one disk, the dispersing degree of the file can be measured based on distance of tracks where the file is placed, movement distance of head, or the time required for accessing the whole file. If the storage system includes more than one disk, the dispersing degree can also be measured based on access time between the disks. The dispersing degree of a set of files is sum of the dispersing degrees of all files in the set.

Then, at Step 205, the one or more sets of files are sequenced based on their dispersing degrees. And then, Step 110 is performed on the sequenced sets of files, i.e. firstly the set of files with maximum dispersing degree is collectively placed in one storage region; and then the other sets of files which have the access correlation with each other are placed in descending order according to their dispersing degrees.

Alternatively, the placement optimization can also be performed only on the set of files with maximum dispersing degree, and Step 110 is performed on the other sets of files randomly or in sequence.

It can be seen from above description that the method for optimizing file placement in a storage system of this embodiment can determine which set of files should be optimized in the file placement firstly by collecting current allocation information of the files in the storage system.

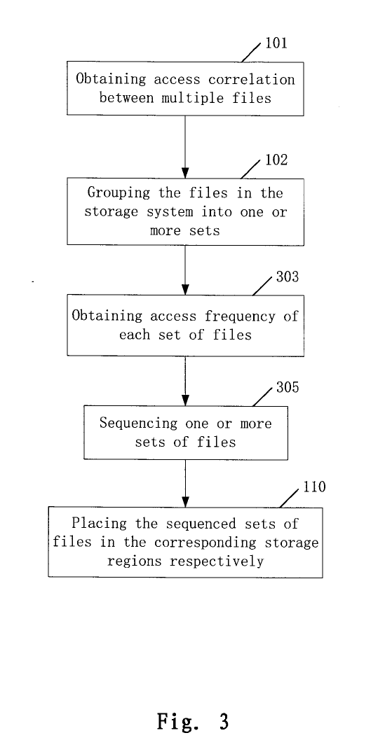

FIG. 3 is a flowchart of a method for optimizing file placement in a storage system according to another embodiment of the present invention, wherein the same parts as those of the previous embodiments use the same reference numbers and their descriptions are omitted properly. This embodiment will be described in details as below in conjunction with the drawing.

As shown in FIG. 3, after Step 102 of FIG. 1 is performed, at Step 303, access frequency of each set of files in the storage system can be obtained. The access frequency of a set of files is sum of the access frequencies of all files in the set. Then, at Step 305, the one or more sets of files are sequenced based on their access frequencies, and then Step 110 is performed on the sequenced sets of files, i.e. firstly the set of files with highest access frequency is collectively placed in one high-speed storage region; and then the other sets of files which have the access correlation with each other are placed in descending order in sub-high-speed storage regions according to their access frequencies.

Alternatively, only the set of files with highest access frequency can be placed in the high-speed storage region, and Step 110 is performed on the other sets of files randomly or in sequence.

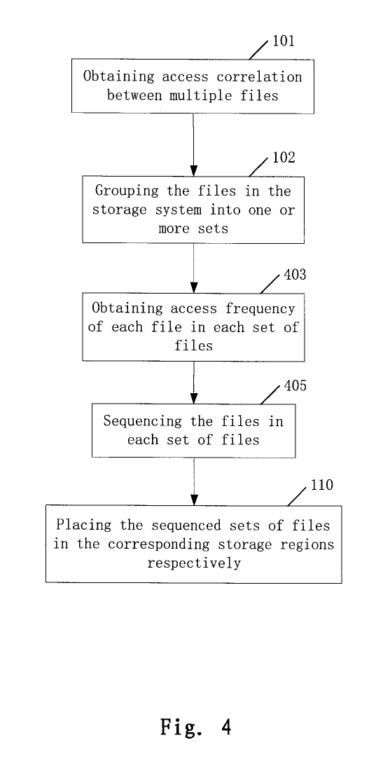

FIG. 4 is a flowchart of a method for optimizing file placement in a storage system according to another embodiment of the present invention, wherein the same parts as those of the previous embodiments use the same reference numbers and their descriptions are omitted properly. This embodiment will be described in details as below in conjunction with the drawing.

As shown in FIG. 4, after Step 102 of FIG. 1 is performed, at Step 403, for each set of files, access frequency of each file in the storage system can be obtained. Then, at Step 405, all files in each of the sets are sequenced within the set based on their access frequencies, and then Step 110 is performed on each set of files, i.e. for each set of files, the files with high access frequency are placed in the storage locations with fast access speed of the storage region; while the files with low access frequency are placed in the storage locations with slow access speed of the storage region. The so-called storage location with fast access speed can be a storage location accessed first, a storage location which is close to the head, a storage location accessed frequently, or a location where a storage device with higher efficiency is positioned.

Alternatively, for a particular set of files, only the file with highest access frequency can be placed in the storage location with fast access speed of the storage region and the other files are placed in the storage region randomly.

In this way, the file access performance of applications can be improved greatly by placing the files with high access frequency in the storage region with fast access speed.

In addition, the embodiment shown in FIG. 4 can be combined with the embodiment shown in FIG. 2, i.e. the one or more sets are sequenced according to their dispersing degrees to obtain the priority order of the sets for optimization, and then all files of each set are sequenced according to their access frequencies. Finally, Step 110 is performed on each set of files according to the priority order for optimization. Of course, only a set of files with maximum dispersing degree can be obtained, or for each set of files, only the file with highest access frequency is obtained, and then Step 110 is performed.

In addition, the embodiment shown in FIG. 4 can also be combined with the embodiment shown in FIG. 3, i.e. the one or more sets are sequenced according to their access frequencies, and then all files of each set are sequenced according to their access frequencies. Finally, Step 110 is performed on each set of files, i.e. the sets with high access frequency are placed in the high-speed storage region of the storage system, and the files with high access frequency of each set are placed in the storage location with fast access speed of the storage region corresponding to the set. Of course, only a set with maximum dispersing degree can be obtained, or for each set, only the file with highest access frequency is obtained, and then Step 110 is performed.

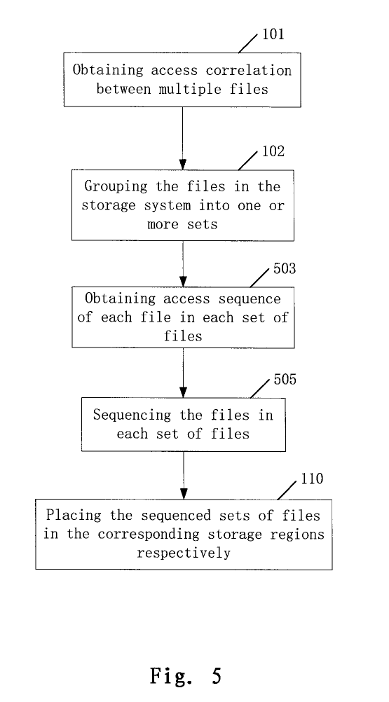

FIG. 5 is a flowchart of a method for optimizing file placement in a storage system according to another embodiment of the present invention, wherein the same parts as those of the previous embodiments use the same reference numbers and their descriptions are omitted properly. This embodiment will be described in details as below in conjunction with the drawing.

As shown in FIG. 5, after Step 102 of FIG. 1 is performed, at Step 503, for each set of files, access sequence of the files in the storage system can be obtained. It can be achieved by analyzing the access behaviors of an application. In this embodiment, the access sequence of a set of files which have access correlation with each other is a sequence with which all files in the set are accessed when an application is performed.

Then, at Step 505, all files in each set are sequenced within the set according to the access sequence, and then Step 110 is performed on each set of files, i.e. for each set of files, all files in the set are placed collectively in one storage region according to the access sequence. Thus, the files which have access correlation with each other are not only collectively placed in one storage region, but also placed according to the access sequence, thereby further improving the file access performance of the application.

In addition, the embodiment shown in FIG. 5 can be combined with the embodiment shown in FIG. 2, i.e. firstly the one or more sets are sequenced according to their dispersing degrees to obtain the priority order of the sets for optimization, and then the files of each set are sequenced according to the access sequence. Finally, Step 110 is performed on each set of files. Of course, Step 110 can be performed only on the set with maximum dispersing degree.

In addition, the embodiment shown in FIG. 5 can be combined with the embodiment shown in FIG. 3, i.e. firstly the one or more sets are sequenced according to their access frequencies to obtain the priority order of the sets for optimization, and then the files of each set are sequenced according to the access sequence. Finally, Step 110 is performed on each set. Of course, Step 110 can be performed only on the set with highest access frequency.

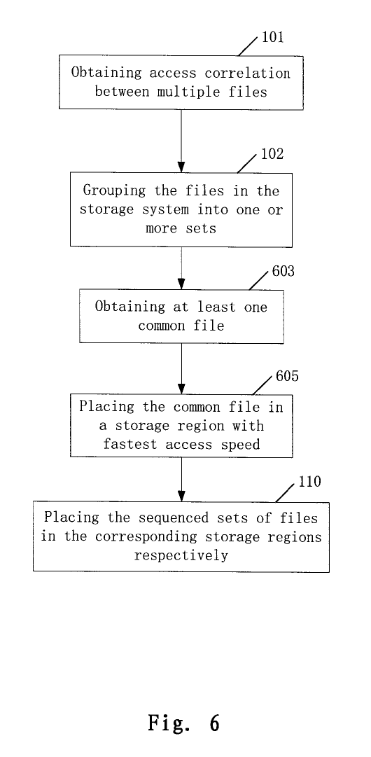

FIG. 6 is a flowchart of a method for optimizing file placement in a storage system according to another embodiment of the present invention, wherein the same parts as those of the previous embodiment use the same reference numbers and their descriptions are omitted properly. This embodiment will be described in details as below in conjunction with the drawing.

As shown in FIG. 6, after Step 102 of FIG. 1 is performed, at Step 603, at least one common file which has the access correlation with a plurality of sets of files is obtained. Then, at Step 605, the common file is placed in the storage region with fastest access speed of the storage system, and then Step 110 is performed on each set of files.

It can be seen from above description that the method for optimizing file placement in a storage system of this embodiment can further place the file common to many applications in the storage region with fastest access speed, thereby further optimizing the placement of the files which have the access correlation.

In addition, the embodiment shown in FIG. 6 can also be combined with other embodiments as described above, which can be obtained easily for persons skilled in the art and the corresponding description is omitted here.

The embodiments of the method for optimizing file placement in a storage system are illustrated in the above. However, according to the above description, persons skilled in the art can associate other variants which are included in the scope of the present invention.

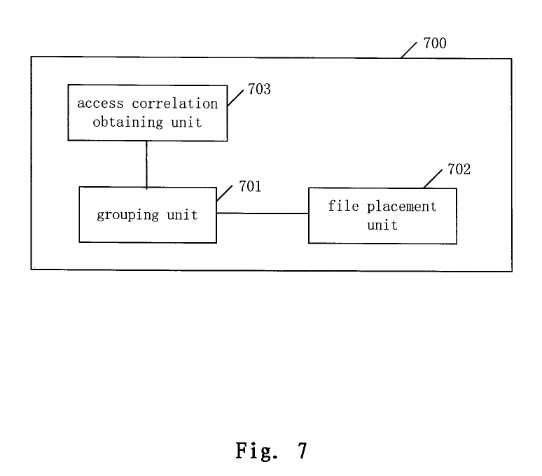

Under the same inventive concept, FIG. 7 is a schematic block diagram of a device for optimizing file placement in a storage system according to one embodiment of the present invention. This embodiment is described in details as below in conjunction with the drawing and the descriptions of the same parts as those of the previous embodiments are omitted properly.

As shown in FIG. 7, the device 700 for optimizing file placement in a storage system of this embodiment comprises: a grouping unit 701 for grouping multiple files in the storage system into at least one set according to access correlation between the multiple files; and a file placement unit 702 for placing each of the at least one set of files collectively in one storage region of the storage system.

Specially, the grouping unit 701 groups the files which have the access correlation into one set. If there is one access correlation between all files in the storage system, all files are grouped into one set. If there are multiple access correlations, all files are grouped into a plurality of sets. The files within each set have the access correlation with each other. Then, the file placement unit 702 places each set of files which have the access correlation with each other collectively in one storage region of the storage system so that the application can read the files continuously when it accesses the related files.

In addition, the device 700 for optimizing file placement in a storage system of this embodiment further comprises: an access correlation obtaining unit 703 for obtaining the access correlation between the files in the storage system and providing it to the grouping unit 701. As mentioned in the above, the access correlation is factors which affect speed of accessing the multiple files by the storage system.

Specially, the access correlation obtaining unit 703 can obtain the access correlation between the files according to the contents of at least one of the files in the storage system. If the file is of a markup language format, the access correlation obtaining unit 703 can analyze the reference relationship between one file and the other one or more files to obtain the access correlation between the files.

Further, the access correlation obtaining unit 703 can analyze a database to obtain the access correlation between the files. As described in the above, the access correlation can be known according to the structure of the database. In this case, the access correlation obtaining unit 703 is required to support the corresponding functions of analyzing database.

Further, the access correlation obtaining unit 703 can analyze the behaviors of an application to obtain the access correlation between the files. In this case, monitoring and analyzing the application by the access correlation obtaining unit 703 are required to be supported by an operating system.

Then, the access correlation between the files obtained by the access correlation obtaining unit 703 is provided to the grouping unit 701 as a basis of grouping the files in the storage system.

It would be noticed that the device 700 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software. The device 700 for optimizing file placement in a storage system of this embodiment can operationally perform the method for optimizing file placement in a storage system of the embodiment as shown in FIG. 1.

It can be seen from above description that the device for optimizing file placement in a storage system of the embodiment can obtain the access correlation between the files and place the files which have the access correlation with each other collectively in one storage region so that the application can access the associated files conveniently, thereby improving the file access performance of the application and reducing the cost of the resources such as CPU, memory, or I/O interface.

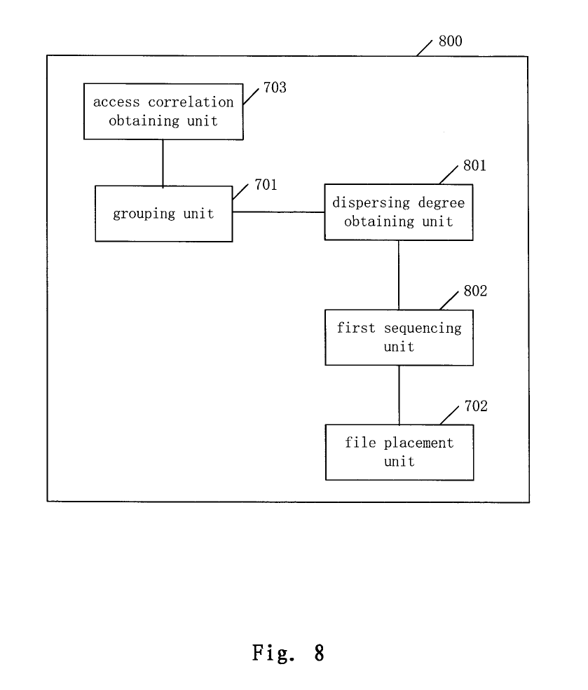

FIG. 8 is a schematic block diagram of a device for optimizing file placement in a storage system according to another embodiment of the present invention; wherein the same parts as those of the previous embodiments use the same reference numbers and their descriptions are omitted properly. This embodiment will be described in details as below in conjunction with the drawing.

As shown in FIG. 8, on the basis of the device 700 of optimizing file placement in a storage system as shown in FIG. 7, the device 800 for optimizing file placement in a storage system of this embodiment further comprises: a dispersing degree obtaining unit 801 for obtaining the dispersing degree of each of one or more sets of files grouped by the grouping unit 701; and a first sequencing unit 802 for sequencing the one or more sets according to their dispersing degrees.

In this embodiment, when the grouping unit 701 groups the files in the storage system into one or more sets, the dispersing degree obtaining unit 801 obtains the dispersing degree of each set of files by measuring the locations of the files of each set of files in the storage system. Then, the first sequencing unit 802 sequences these sets according to their dispersing degrees and provides the sequenced sets to the file placement unit 702. The file placement unit 702 places the set of files with maximum dispersing degree in one storage region and places the other sets of files in the corresponding storage regions in descending order according to the dispersing degrees. Alternatively, the file placement unit 702 can only place the set of files with maximum dispersing degree in one storage region.

It would be noticed that the device 800 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software. The device 800 for optimizing file placement in a storage system of this embodiment can operationally execute the method for optimizing file placement in a storage system of the embodiment shown in FIG. 2.

It can be seen from above description that the device for optimizing file placement in a storage system of this embodiment can further collect the current allocation information of the files in the storage system to determine which set of files should be optimized in the file placement firstly.

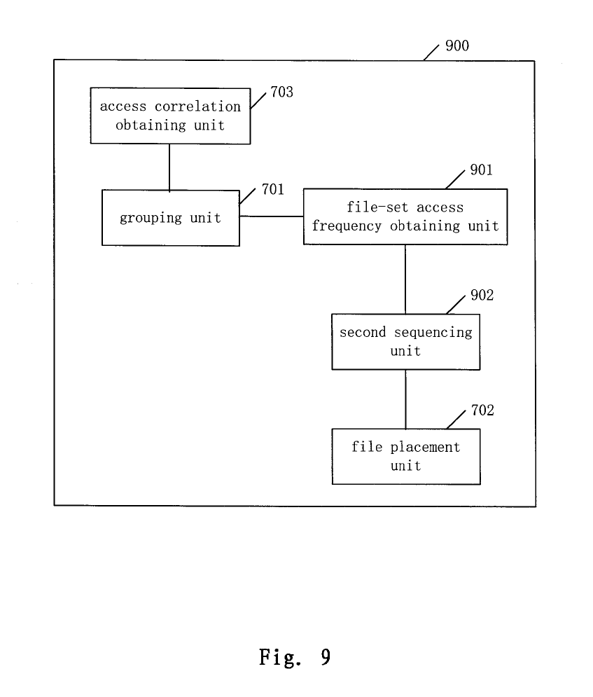

FIG. 9 is a schematic block diagram of a device for optimizing file placement in a storage system according to another embodiment of the present invention, wherein the same parts as those of the previous embodiment use the same reference numbers and their descriptions are omitted properly. This embodiment will be described in details as below in conjunction with the drawing.

As shown in FIG. 9, on the basis of the device 700 of optimizing file placement in a storage system as shown in FIG. 7, the device 900 for optimizing file placement in a storage system of this embodiment further comprises: a file-set access frequency obtaining unit 901 for obtaining access frequency of each of one or more sets of files grouped by the grouping unit 701; and a second sequencing unit 902 for sequencing the one or more sets according to their access frequencies obtained by the file-set access frequency obtaining unit 901.

In this embodiment, when the grouping unit 701 groups the files in the storage system into one or more sets, the file-set access frequency obtaining unit 901 obtains the access frequencies of the sets of files, wherein the access frequency of a set of files is sum of the access frequencies of all files in the set. Then, the access frequencies of the sets of files are provided to the second sequencing unit 902 for sequencing these sets of files, and the sequenced sets of files are provided to the file placement unit 702. The file placement unit 702 places the set of files with highest access frequency in one high-speed storage region and then places the other sets of files in descending order in sub-high-speed storage regions according to their access frequencies. Alternatively, the file placement unit 702 can only place the set of files with highest access frequency in one high-speed storage region.

It would be noticed that the device 900 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software. The device 900 for optimizing file placement in a storage system of this embodiment can operationally perform the method for optimizing file placement in a storage system of the embodiment shown in FIG. 3.

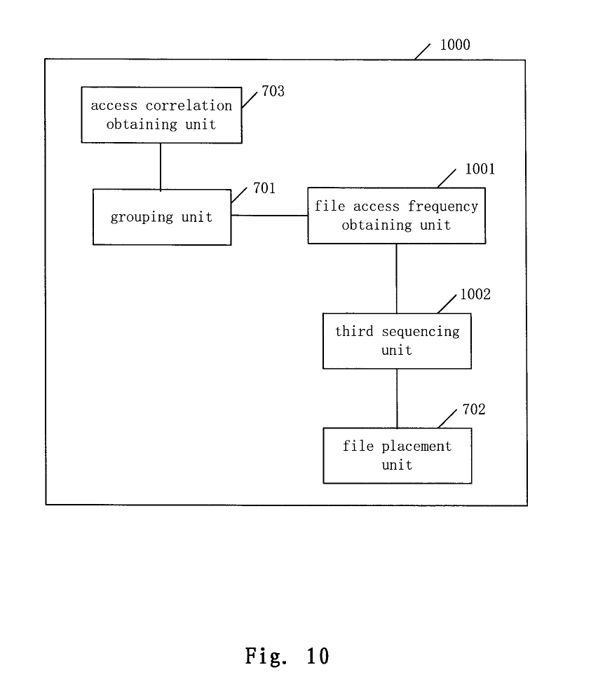

FIG. 10 is a schematic block diagram of a device for optimizing file placement in a storage system according to another embodiment of the present invention, wherein the same parts as those of the previous embodiment use the same reference numbers and their descriptions are omitted properly. The embodiment will be described in details as below in conjunction with the drawing.

As shown in FIG. 10, on the basis of the device 700 of optimizing file placement in a storage system as shown in FIG. 7, the device 1000 for optimizing file placement in a storage system of this embodiment further comprises: a file access frequency obtaining unit 1001, which, for each set of files of one or more sets grouped by the grouping unit 701, obtains the access frequencies of the files in the set; and a third sequencing unit 1002 for sequencing the files of each set according to their access frequencies within the set.

In this embodiment, when the grouping unit 701 groups the files in the storage system into one or more sets, the file access frequency obtaining unit 1001 obtains the access frequencies of the files of each set. Then, the access frequencies of the files of each set are provided to the third sequencing unit 1002 for sequencing the files within the set, and the sequenced sets of files are provided to the file placement unit 702. The file placement unit 702 places each set of files collectively in one storage region of the storage system, and places the files with high access frequency in the storage locations with fast access speed of the storage region corresponding to the set of files and places the files with low access frequency in the storage locations with slow access speed of the storage region. Alternatively, the file placement unit 702 only places the files with high access frequency of each set in the storage locations with fast access speed of the storage region corresponding to the set of files.

In this way, the file access performance of the application can be improved greatly by placing the files with high access frequency in the storage regions with fast access speed.

It would be noticed that the device 1000 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software. The device 1000 for optimizing file placement in a storage system of this embodiment can operationally perform the method for optimizing file placement in a storage system of the embodiment as shown in FIG. 4.

In addition, the embodiment shown in FIG. 10 can be combined with the embodiment shown in FIG. 8, i.e. when the grouping unit 701 groups the files in the storage system into one or more sets, the dispersing degree obtaining unit 801 obtains the dispersing degree of each set of files and the file access frequency obtaining unit 1001 obtains the access frequencies of the files of each set. Then, the first sequencing unit 802 sequences these sets according to their dispersing degrees, and then the third sequencing unit 1001 sequences the files of each set within the set. The sequenced sets of files are provided to the file placement unit 702. The file placement unit 702 firstly places the set of files with maximum dispersing degree in one storage region and then places the other sets of files in the corresponding storage regions in descending order according to the dispersing degrees. Then, for each set of files, the files with high access frequency are placed in the storage locations with fast access speed of the storage region corresponding to the set of files and the files with low access frequency are placed in the storage locations with slow access speed in the storage region. Alternatively, the file placement unit 702 can only place the set of files with maximum dispersing degree in one storage region and place the files thereof in the storage locations with fast or slow access speed of the storage region according to the high or low access frequency; or the file placement unit 702 can only place the files with high access frequency of each set of files in the storage location with fast access speed of the storage region corresponding to the set of files.

In addition, the embodiment shown in FIG. 10 can be combined with the embodiment shown in FIG. 9, i.e. when the grouping unit 701 groups the files in the storage system into one or more sets, the file-set access frequency obtaining unit 901 obtains the access frequencies of the one or more sets of files and the file access frequency obtaining unit 1001 obtains the access frequencies of the files of each set of files. And then, the access frequencies of the one or more sets of files are provided to the second sequencing unit 902 for sequencing these sets and then the third sequencing unit 1001 sequences the files of each set within the set. The sequenced sets of files are provided to the file placement unit 702. The file placement unit 702 places the set of files with highest access frequency of the one or more sets in one high-speed storage region and then places the other sets of files in sub-high-speed storage regions in descending order according to their access frequencies. Then, for each set of files, the files with high access frequency are placed in the storage locations with fast access speed of the storage region corresponding to the set of files and the files with low access frequency are placed in the storage locations with slow access speed of the storage region. Alternatively, the file placement unit 702 can only place the set of file with highest access frequency in one high-speed storage region and place the files thereof in the storage locations with fast or slow access speed of the storage region according to the high or low access frequency; or the file placement unit 702 can only place the files with high access frequency of each set of files in the storage location with fast access speed of the storage region corresponding to the set of files.

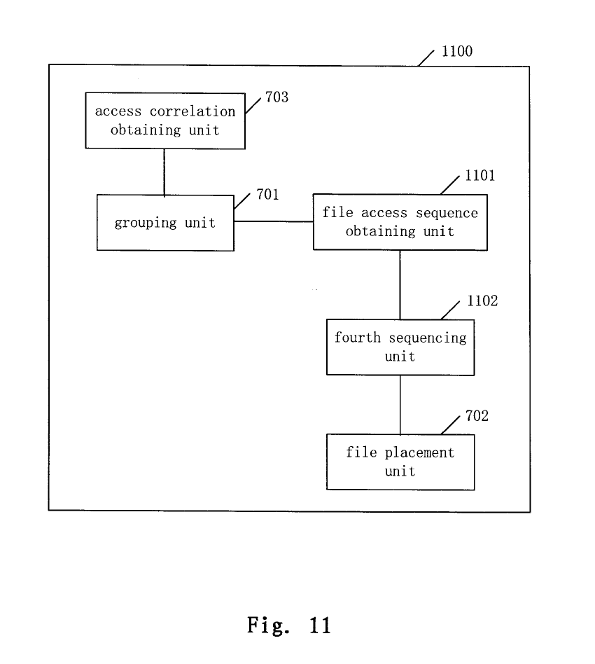

FIG. 11 is a schematic block diagram of a device for optimizing file placement in a storage system according to another embodiment of the present invention; wherein the same parts as those of the previous embodiment use the same reference numbers and their descriptions are omitted properly. This embodiment will be described in details as below in conjunction with the drawing.

As shown in FIG. 11, on the basis of the device 700 for optimizing file placement in a storage system as shown in FIG. 7, the device 1100 for optimizing file placement in a storage system of this embodiment further comprises: a file access sequence obtaining unit 1101 for obtaining, for each set of the one or more sets grouped by the grouping unit 701, access sequence of the files of the set in the storage system; and a fourth sequencing unit 1102 for sequencing the files of each set according to the access sequence within the set.

In this embodiment, when the grouping unit 701 groups the files in the storage system into one or more sets, the file sequence obtaining unit 1101 obtains the access sequence of the files of each set of files in the storage system. As described above, the access sequence of a set of files which have the access correlation is the sequence with which the files of the set are accessed when an application is performed. And then the fourth sequencing unit 1102 sequences the files of each set according to the access sequence. The sequenced sets of files are provided to the file placement unit 702. The file placement unit 702 places each set of files in one storage region and the files of each set are placed according to the access sequence.

It would be noticed that the device 1100 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software. The device 1100 for optimizing file placement in a storage system of this embodiment can operationally perform the method for optimizing file placement in a storage system of the embodiment as shown in FIG. 5.

In addition, the embodiment shown in FIG. 11 can be combined with the embodiment shown in FIG. 8, i.e. when the grouping unit 701 groups the files in the storage system into one or more sets, the dispersing degree obtaining unit 801 obtains the dispersing degree of each set of files and the file access sequence obtaining unit 1101 obtains the access sequence of the files of each set. And then the first sequencing unit 802 sequences these sets according to their dispersing degrees and the fourth sequencing unit 1102 sequences the files of each set within the set. The sequenced sets of files are provided to the file placement unit 702. The file placement unit 702 firstly places the set of files with maximum dispersing degree in one storage region and then places the other sets of files in the corresponding storage regions in descending order according to their dispersing degrees, and for each set of files, the files are placed according to the access sequence.

In addition, the embodiment shown in FIG. 11 can be combined with the embodiment shown in FIG. 9, i.e. when the grouping unit 701 groups the files in the storage system into one or more sets, the file-set access frequency obtaining unit 901 obtains the access frequencies of the one or more sets of files and the file access sequence obtaining unit 1101 obtains the access sequence of the files of each set. And then the access frequencies of the sets of files are provided to the second sequencing unit 902 for sequencing these sets and the third sequencing unit 1102 sequences the files of each set within the set. The sequenced sets of files are provided to the file placement unit 702. The file placement unit 702 places the set of files with highest access frequency of the one or more sets in one high-speed storage region and then places the other sets of files in sub-high-speed storage regions in descending order according to their access frequencies, and for each set of files, the files are placed according to the access sequence.

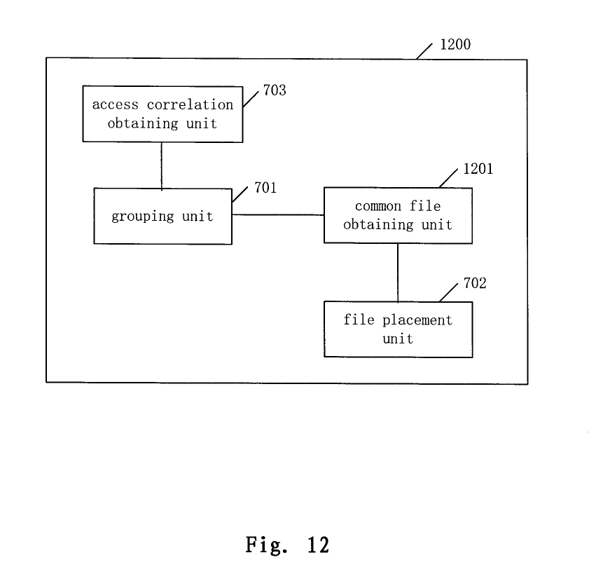

FIG. 12 is a schematic block diagram of a device for optimizing file placement in a storage system according to another embodiment of the present invention, wherein the same parts as those of the previous embodiments use the same reference numbers and their descriptions are omitted properly. This embodiment will be described in details as below in conjunction with the drawing.

As shown in FIG. 12, on the basis of the device 700 for optimizing file placement in a storage system as shown in FIG. 7, the device 1200 for optimizing file placement in a storage system of this embodiment further comprises: a common file obtaining unit 1201 for obtaining at least one common file which has the access correlation with each of the at least one sets of files.

In this embodiment, when the grouping unit 701 groups the files in the storage system into one or more sets, the common file obtaining unit 1201 obtains one or more common files, if any, which have the access correlation with each set of files. Then the file placement unit 702 places the common files in a storage region with fastest access speed of the storage system and places each set of files in one storage region.

As described above, the common file is the file which is common to a plurality of applications and can be accessed frequently by the applications. Therefore, in this embodiment, the common files are placed individually in the storage region with fastest access speed, which can improve the access efficiency of the application.

It would be noticed that the device 1200 for optimizing file placement in a storage system of this embodiment and its components can be implemented by hardware circuit such as Very Large Scale Integrated Circuit or gate array, semiconductor such as logic chips and transistors, or programmable hardware device such as field programmable gate array and programmable logic device, and by software executing on various types of processors, and by the combination of above hardware circuit and software. The device 1200 for optimizing file placement in a storage system of this embodiment can operationally perform the method for optimizing file placement in a storage system of the embodiment as shown in FIG. 6.

In addition, the embodiment shown in FIG. 12 can also be combined with other embodiments as described above, which can be obtained easily for persons skilled in the art and the corresponding description is omitted here.

It can be seen from above description that the device for optimizing the file placement in a storage system of this embodiment can further place the files common to a plurality of applications individually in the storage region with fastest access speed, thereby further optimizing the placement of the files in the storage system.

The present invention can be embodied in a computer program product which comprises all features capable of implementing the methods described in this description and can perform these methods when it was loaded into a computer system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

Although the method and device for optimizing file placement in a storage system of the present invention are described in detail accompanying with the specified embodiments in the above, the present invention is not limited as above. It should be understood by persons skilled in the art that the above embodiments may be varied, replaced or modified without departing from the spirit and the scope of the present invention.

1. A method for optimizing file placement in a storage system, comprising:
grouping multiple files into at least one set according to access correlation between the multiple files in the storage system; and
placing each of the at least one set of files collectively in one storage region of the storage system.

2. The method of claim 1, further comprising: obtaining the access correlation between the multiple files in the storage system.

3. The method of claims 2, wherein the step of obtaining the access correlation between the multiple files in the storage system comprises: obtaining the access correlation between the multiple files according to contents of at least one of the multiple files.

4. The method of claim 3, wherein at least one of the multiple files is of a markup language format;
and wherein the step of obtaining the access correlation between the multiple files comprises: analyzing reference relationship between the at least one file and other one or more files to obtain the access correlation between the multiple files.

5. The method of claim 2, wherein the step of obtaining the access correlation between the multiple files comprises: analyzing a database to obtain the access correlation between the multiple files.

6. The method of claim 2, wherein the step of obtaining the access correlation between the multiple files comprises: analyzing behaviors of an application to obtain the access correlation between the multiple files.

7. The method of claim 2, wherein the step of obtaining the access correlation between the multiple files comprises: marking the access correlation between the multiple files directly by a user.

8. The method of claim 1, further comprising: obtaining dispersing degree of each of the at least one set of files; and sequencing the at least one set according to the dispersing degrees;
wherein the placing step comprises: placing the set of files with maximum dispersing degree and then placing the other sets of files in descending order according to their dispersing degrees; or only placing the set of files with maximum dispersing degree.

9. The method of claim 1, further comprising: obtaining access frequency of each of the at least one set of files; and sequencing the at least one set according to the access frequencies;
wherein the placing step comprises: placing the set of files with highest access frequency in one high-speed storage region and then placing the other sets of files in sub-high-speed storage regions in descending order according to their access frequencies; or only placing the set of files with highest access frequency in one high-speed storage region.

10. The method of claim 1, further comprising: for each of the at least one set of files, obtaining access frequencies of the files of the set; and sequencing the files of each set according to their access frequencies within the set;
wherein the placing step comprises: for each set of files, placing the files with high access frequencies in storage locations with fast access speed of the storage region corresponding to the set of files; and placing the files with low access frequencies in storage locations with slow access speed of the storage region corresponding to the set of files.

11. The method of claim 1, further comprising: for each of the at least one set of files, obtaining access sequence of the files of the set; and sequencing the files of each set according to the access sequence within the set;
wherein the placing step comprises: for each set of files, placing the files in the storage region corresponding to the set of files according to the access sequence.

12. The method of claim 11, wherein the access sequence of the files of the set is a sequence with which the files of the set are accessed when an application is performed.

13. The method of claim 1, further comprising: before the placing step, obtaining a file which has the access correlation with each of the at least one set of files; and
placing the file which has the access correlation with each of the at least one set of files in a storage region with fastest access speed of the storage system.

14. A device for optimizing file placement in a storage system, comprising:
a grouping unit for grouping multiple files into at least one set according to access correlation between the multiple files in the storage system; and
a file placement unit for placing each of the at least one set of files collectively in one storage region of the storage system.

15. The device of claim 14, further comprising: an access correlation obtaining unit for obtaining the access correlation between the multiple files in the storage system.

16. The device of claims 15, wherein the access correlation obtaining unit obtains the access correlation between the multiple files according to contents of at least one of the multiple files.

17. The device of claim 15, wherein at least one of the multiple files is of a markup language format;
and wherein the access correlation obtaining unit analyzes reference relationship between the at least one file and other one or more files to obtain the access correlation between the multiple files.

18. The device of claim 15, wherein the access correlation obtaining unit analyzes a database to obtain the access correlation between the multiple files.

19. The device of claim 15, wherein the access correlation obtaining unit analyzes behaviors of an application to obtain the access correlation between the multiple files.

20. A computer program product comprising a computer usable medium having computer usable program code for optimizing file placement in a storage system, said computer program product including:
computer usable program code for grouping multiple files into at least one set according to access correlation between the multiple files in the storage system; and
computer usable program code for placing each of the at least one set of files collectively in one storage region of the storage system.
